(19) United States
(12) Patent Application Publication
(10) Pub. No.: US 2010/0247279 A1
(43) Pub. Date: Sep. 30, 2010

(54) Transport Device for Vessels

(76) Inventor: Otger Robert I Boluda, Granollers (ES)

Correspondence Address: RICHARD M. GOLDBERG, 25 EAST SALEM STREET, SUITE 419, HACKENSACK, NJ, 07601, US

(21) Appl. No.: 12/739,784

(22) PCT Filed: Oct. 29, 2008
(86) PCT No.: PCT/ES2008/000667

§ 371 Date: Apr. 26, 2010

(30) Foreign Application Priority Data
Oct. 31, 2007 (ES) U200702216

(51) Int. Cl. B60P 3/10; B60P 1/43; B62D 55/00

(52) U.S. Cl. 414/529; 414/538

(57) ABSTRACT

The device includes a chassis (1) with an engine (2) associated with two side transport caterpillar tracks (3), with a vessel-housing cradle (4) in the upper part of the chassis (1), with this cradle (4) presenting a pulley (61) at its front end, on which a traction cable (62) is guided that is associated with a winch (6) and, at its rear end there is at least one telescopic element (41), defined by two longitudinal parallel rear extension stringers. The engine (2) is associated with one end of a vertical shaft (22) by a belt (21), while the other end is associated with two belts (23, 24) that provide power to the winch (6) and to a mechanical reducer (5) associated with the caterpillar track drive crown.

### OBJECT OF THE INVENTION

This invention refers to a transport device for vessels for launching and extracting them from the water along beaches and seashores.

### BACKGROUND OF THE INVENTION

The transport of small vessels and jet skis by road commonly uses small trailers hooked to vehicles in order to move them from one point to another, for example, from a garage or other storage location to the seashore so that the vessel can be launched into the water.

This launching operation is carried out by moving the trailer into the water until the vessel or jet ski is more or less floating on the water surface or it is easy to move it until it is floating. This involves several problems with moving the vessel into the water using the tow vehicle, with the associated risk of this vehicle becoming trapped and also, in certain cases, the tow vehicle has to partially enter the seawater, which can easily cause considerable corrosion and other damage to metal parts and electric components.

The Spanish Utility model ES213899U, “Auxiliary drive device for vessel trailer-supports” is known, which describes a conventional vessel trailer towed by a vehicle that is fitted with a continuous belt combined with a self-propulsion engine and belt lifting and lowering mechanism, so that, when the trailer is moved over the beach to the seashore this belt is activated, allowing it to descend and move the trailer in a completely self-propelled manner, without any need to use the vehicle, which can be left at a certain distance without having to cross the sand or enter any areas of complicated access.

This device represents a great advantage because it permits movement to the seashore without having to use any vehicle; however, it is still necessary for the trailer to enter the water with the subsequent deterioration by corrosion.

### DISCLOSURE OF THE INVENTION

The vessel transport device covered by this invention presents certain technical peculiarities intended to facilitate the job of entering and removing jet skis and small and medium vessels from the water by autonomous means that can be easily loaded on a low trailer or platform.

The device comprises a chassis with an engine associated with two side transport caterpillar tracks, with a vessel or water ski housing cradle in the upper part of the chassis. The front part of this cradle is convergently extended into a handling mast fitted with a pulley or winding drum for guiding a traction cable associated with a winch that allows the vessel to be easily raised on to the cradle.

Thus, this device can be easily moved over the sand by means of its tracks and mounted onto the low trailer that is used to facilitate transporting the vessel by road using a vehicle. At the unloading destination, the device enables the vessel to be removed from the trailer in a simple fashion and take it to the seashore without the vehicle and the trailer so that all corrosion damage due to contact with seawater is avoided, together with the risk of becoming bogged down in the sand.

The engine is connected to one end of a vertical shaft by a belt, with the other end being associated with two belts that provide power to the winch and a mechanical reducer associated with the track drive crowns. In this way, full automation of all the moving elements on the device is achieved.

The cradle has at least one telescopic element at its rear end, which is defined by two longitudinal parallel rear extension stringers that establishes an easy descent path to the water for the vessel, thus the engine and other mechanical elements do not come into contact with the water.

The cradle presents lateral rollers in a “V” configuration that support the vessel in a stable, centred fashion. In turn, the central part of the cradle and telescopic elements comprise guide rollers for the vessel keel.

The cradle and telescopic elements are arranged with a certain inclination that descends to the rear that facilitates vessel movement to and from the transport device.

### DESCRIPTION OF THE FIGURES

To complement the description being made and in order to facilitate the understanding of the invention characteristics, this descriptive report is accompanied by a set of drawings which, with an illustrative, non-limiting manner, represents the following:

FIG. 1 is a perspective view of the transport device.

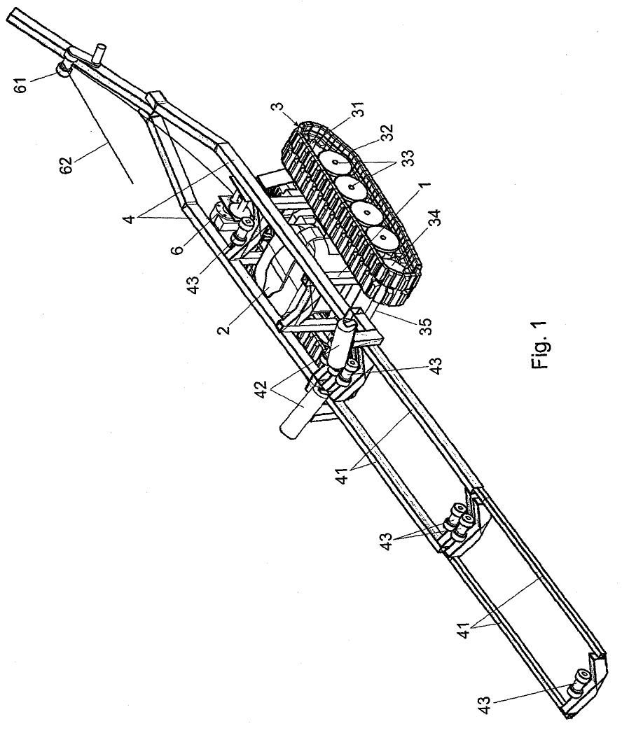

FIG. 2 shows a profile view of the device.

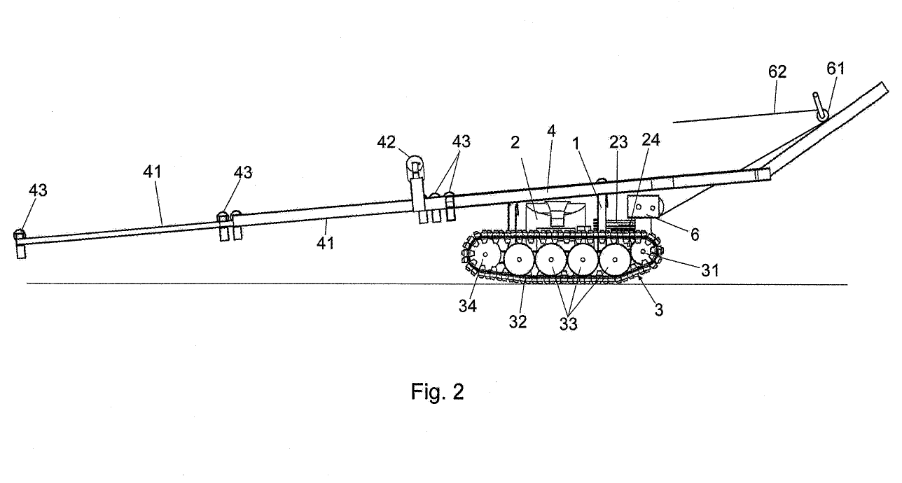

FIG. 3 is a plan view of the device.

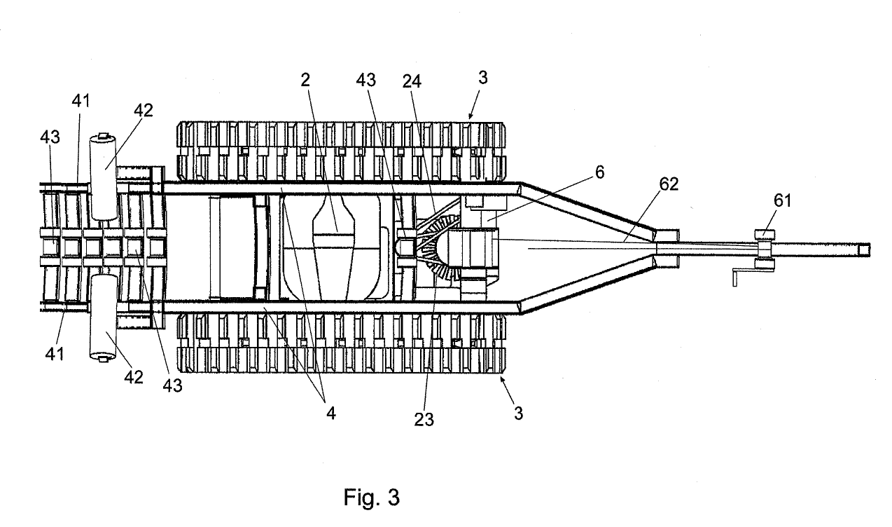

FIG. 4 illustrate an elevation view of the device.

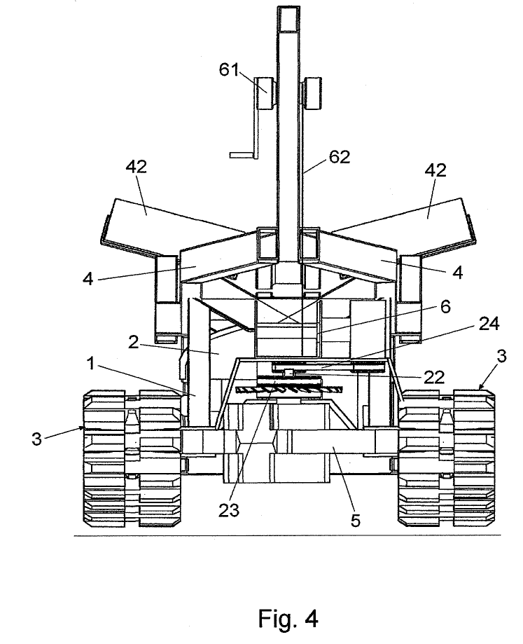

FIG. 5 shows a lower view of the device.

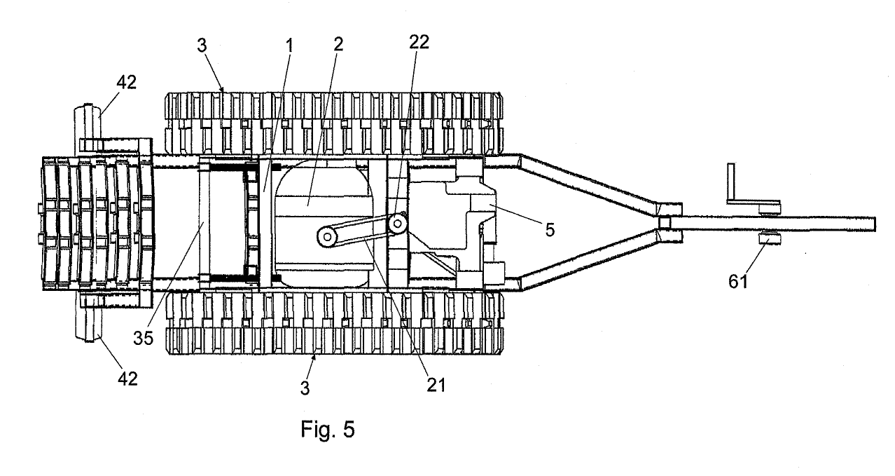

### EXEMPLARY EMBODIMENT OF THE INVENTION

As can be seen in the referenced figures, the vessel transport device comprises a chassis (1) with an engine (2) in a central arrangement, with two caterpillar tracks (3) arranged at the sides associated with the chassis (1) and an upper cradle (4) for housing and supporting the vessel.

The motor (2) shaft is associated with a belt (21) that leads to a vertical shaft (22) in a pulley at its lower end. In turn, this shaft (22) is associated, by two belts (23, 24), arranged at the other end, with a reducer (5) that transmits power to the tracks (3) and an upper winch (6) under the cradle (4).

The cradle (4) is convergently extended at the front part of the device, where a traction pulley (61) is installed, which is fitted with the winch (6) cable (62) for loading the vessel by means of the engine (2) or to allow the vessel to smoothly slide when it is launched.

In turn, the reducer (5) is configured on a front bridge with a differential, gearbox and clutch that is connected by its ends to two toothed movement crowns (31) for the respective belts (32) on each track (3). Each track comprises lower support wheels (33) and a rear belt (32) tension wheel (34) by means of a tensioning element (35).

The cradle (4) is slightly inclined downward at its rear part, where there are two telescopic elements (41), configured by sets of parallel stringers that are joined at their far ends, configuring a movement path for the vessel during loading and unloading. At its rear part, the cradle (4) presents at least two lateral, vessel support rollers (42) in a “V” arrangement and, in turn, guide rollers (43) for the central part of the keel, also on said cradle (4) and said telescopic elements (41).

When the nature of the invention is sufficiently described, together with an exemplary embodiment, it is put on the record that the materials, form, size and arrangement may be modified, provided that this does not involve any alterations to the essential characteristics of the invention, which are claimed below.

What is claimed is:

1. A vessel transport device, comprising:
a chassis;
an engine mounted to the chassis;
two side transport caterpillar tracks driven by the engine;
a vessel-housing cradle in the upper part of the chassis for supporting a vessel;
a pulley mounted at a front end of the cradle;
a traction cable guided on the pulley;
a winch associated with the pulley; and
at least one telescopic element at a rear end of the cradle, defined by two longitudinal parallel rear extension stringers.

2. A device in accordance with claim 1,
wherein the caterpillar tracks have a drive crown; and further comprising:
a mechanical reducer associated with the caterpillar tracks drive crown;
a vertical shaft having one end associated with the engine through a belt, and
two belts associated with an opposite end of the shaft and which provide power to the winch and to the mechanical reducer.

3. A device in accordance with claim 1, wherein the cradle includes at least two lateral rollers in a “V” arrangement in order to support the vessel.

4. A device in accordance with claim 1, wherein a central part of the cradle and the at least one telescopic element comprise guide rollers for a keel of the vessel.

5. A device in accordance with claim 1, wherein the cradle and the at least one telescopic element present a downward inclination toward a rear thereof.
